(19) United States
(12) Patent Application Publication
(10) Pub. No.: US 2020/0043302 A1
(43) Pub. Date: Feb. 6, 2020

(54) Information Prompt Method, Electronic Device and Computer Readable Storage Medium

(71) Applicant: AAC ACOUSTIC TECHNOLOGIES (SHENZHEN) CO., LTD., Shenzhen (CN)

(72) Inventors: Yao Wang, Shenzhen (CN); Jiaying Gu, Shenzhen (CN)

(21) Appl. No.: 16/524,059

(22) Filed: Jul. 27, 2019

(30) Foreign Application Priority Data
Aug. 2, 2018 (CN) 201810871346.7

(51) Int. Cl. G08B 6/00

(52) U.S. Cl. CPC G08B 6/00; H04B 1/385

(57) ABSTRACT

The present invention provides an information prompt method, including steps of: determining a current state of an electronic device after receiving a prompt information, wherein, the current state of the electronic device includes a motion state and a static state; determining a corresponding vibration information according to the current state of the electronic device; generating vibration according to the vibration information. The present invention further provides an electronic device.

### FIELD OF THE PRESENT DISCLOSURE

The embodiments of the invention relate to the electronic information technical field, in particular to an information prompt method, an electronic device and a computer readable storage medium.

### DESCRIPTION OF RELATED ART

At present, the vibration function in the terminal device is realized by giving the corresponding signal to the vibration component in the device, such as mobile phones, smart watches, AR glasses, etc., which all have the vibration function. There are many types of vibration signals in the existing terminal devices, and users can set different types of vibration signals according to the actual needs.

However, the inventor of the invention finds that users of the existing terminal devices can set different vibration signals according to the needs, but the terminal devices cannot switch the vibration signals according to the change of the current terminal device stat. Because users have different perceptions of the vibration signal intensity in different use occasions, for example, if the vibration signal intensity set by the user is low and when the user is at a bodybuilding activity, the user cannot be able to be aware of the vibration prompt, which causes the user to miss the phone, information, etc.

### BRIEF DESCRIPTION OF THE DRAWINGS

Many aspects of the exemplary embodiment can be better understood with reference to the following drawings. The components in the drawing are not necessarily drawn to scale, the emphasis instead being placed upon clearly illustrating the principles of the present disclosure.

FIG. 1 is a flowchart of an information prompt method in accordance with a first embodiment of the invention.

FIG. 2 is a flowchart of an information prompt method in accordance with a second embodiment of the invention.

FIG. 3 is an illustrative view of an electronic device in accordance with a third embodiment of the invention.

### DETAILED DESCRIPTION OF THE EXEMPLARY EMBODIMENTS

The present disclosure will hereinafter be described in detail with reference to an exemplary embodiments. To make the technical problems to be solved, technical solutions and beneficial effects of the present disclosure more apparent, the present disclosure is described in further detail together with the figures and the embodiments. It should be understood the specific embodiment described hereby are only to explain the disclosure, not intended to limit the disclosure.

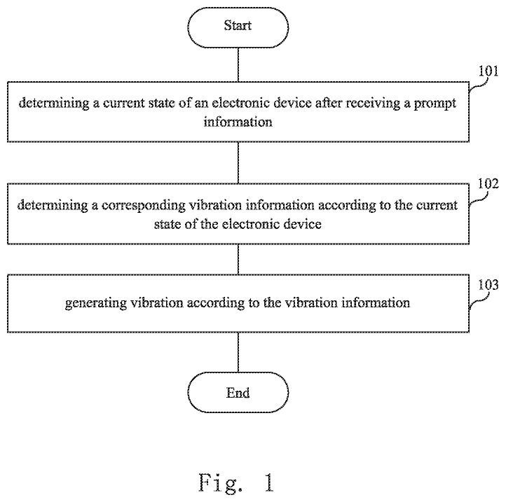

The first embodiment of the invention relates to an information prompt method. The specific flowchart is shown in FIG. 1, and includes the following steps:

Step 101: determine a current state of an electronic device after receiving a prompt information, wherein, the current state of the electronic device includes: a motion state and a static state. It is worth mentioning that the electronic device can be a mobile terminal, a smart watch or any other wearable smart device. No restriction here. It needs to explain that the information prompt method in the invention is not restricted to the current working mode of the electronic device, namely, no matter in the vibration mode or in the non-vibration mode, the electronic device can prompt the information according to the information prompt method. Further, the prompt information includes the call prompt. Short message prompt and chat software information prompt, etc. The type of the specific prompt information is not restricted.

Specifically, the current state of the electronic device can be determined by the data of the sensors in the electronic device, or by the current mode of the electronic device, for example, when the electronic device carried by the user is a smart watch and the step-counting mode is set, the smart device can be determined to be in a motion state according to the current mode of the smart watch, and it can infer that the user may be engaged in a body building activity.

It has to explain that the current state of the electronic device includes the motion state and the static state, which needs to be determined by the sensors related to the motion state of the electronic device. The sensors include an acceleration sensor, a gyroscope sensor, a global positioning system (GPS) sensor and other motion sensors. In the specific implementation, the data information of the sensors in the electronic device are acquired, and the current state of the electronic device is determined according to the data information of the sensors. In practice, it can be determined by the data information of a sensor, such as whether the angle value of the gyro rotor in the gyroscope sensor remains unchanged can be taken as the basis, if yes, the electronic device is in a static state. It can also be determined by the data of multiple sensors, for example, the user carries the electronic device in a uniform motion but the acceleration value obtained by the acceleration sensor is zero, so whether the position is changed is determined according to the data of the GPS positioner, and then the current state of the electronic device is determined. The types of the sensors mentioned above and the determination of the current state of the electronic device based on the data information of the sensors are taken for examples, there is no specific restriction here. In practice, the realization mode of the current state of the electronic device can be determined according to the types of sensors in the electronic device.

Step 102: a corresponding vibration information is determined according to the current state of the electronic device.

Specifically, the current state of the electronic device includes the static state and the motion state, and the vibration information corresponding to the current state of the electronic device includes the vibration information in the motion state and the vibration information in the static state. It needs to explain that the vibration information can also be determined by judging the intensity of the motion state in the electronic device. The description of the vibration here is only a general description. In practice, the vibration information can also be classified with more details, there is no specific restriction here.

In a specific embodiment, when the electronic device is in a static state, it can also be realized by obtaining the data information of the camera sensor. If it determines that the user is watching the electronic device according to the data information of the camera sensor, the vibration intensity of the vibration information shall not be adjusted too high.

In another specific embodiment, when the electronic device is in the motion state, the distance sensor can detect whether the user is using the electronic device to communicate with a telephone call. If the user is communicating, the vibration intensity in the vibration information shall not be adjusted too high, or when the motion sensor detects that the electronic device is in the motion station, if the temperature sensor or tactile sensor detects that the electronic device is held by the user, the vibration intensity in the vibration information shall not be adjusted too high, either.

Specifically, because there are more than one vibration types of electronic devices, multiple ways are used to actually determine the vibration information. One embodiment is as follows: determine the vibration information characteristics corresponding to the current state of the electronic device, and the vibration information is determined according to the vibration information characteristics, wherein, the vibration information includes the vibration information characteristics. The different types of vibration signals may be reflected by different vibration duration, vibration frequencies and vibration intensities. The vibration information characteristics include at least one of the vibration duration, vibration frequency, vibration intensity and vibration direction.

When determining the vibration information characteristics, the vibration duration, vibration frequencies and vibration intensities are classified, for example, the vibration duration is classified into vibration duration 1 and vibration duration 2, the vibration frequencies are classified into vibration frequency 1, vibration frequency 2 and vibration frequency 3, and the vibration intensities are classified into weak vibration intensity, middle vibration intensity and high vibration intensity. When the electronic device is in the static state, the vibration information is determined to be composed of vibration duration 1+vibration frequency 1+middle vibration intensity. Here is just an example without any specific restriction.

It is worth mentioning that the current state of the electronic device is mainly to infer the user's state based on the current state of the electronic device. Because people have different sensitivities to the vibration information in the motion state and static state, for example, when the user is in the motion state, the user may not feel the vibration information with weak vibration intensity, and the user is more sensitive to the vibration information in the static state. Therefore, the characteristic of the vibration information is adjusted when there is the prompt information to make the user feel the vibration as much as possible and prompt the user to view the prompt information received by the electronic device. Different electronic devices have different classifications of vibration information characteristics, Specific vibration information characteristic is not restricted here.

Step 103: vibrate according to the vibration information.

Specifically, after determining the vibration information, the electronic device sends out the vibration according to the vibration information. If the electronic device has only one vibrator, the vibrator vibrates. If the electronic device includes at least two vibrators, one of the realization processes of the electronic device vibration is to obtain the vibration information characteristic in the vibration information; to determine the corresponding vibrator according to the vibration information characteristic; and to send out the vibration information from the corresponding vibrator.

In a specific embodiment, when there are at least two vibrators, different vibration information needs to be driven by different vibrators, for example, the first vibration information is suitable to be sent out through vibrator A, the first vibration information is sent out by the vibrator A; and the second vibration information is suitable to be sent out through vibrator B, the second vibration information is sent out through vibrator B, and the third vibration information is suitable to be sent out through the vibrator A and vibrator B which work at the same time, the vibrator A and vibrator B work at the same time to send out the third vibration information.

In another specific embodiment, at least two vibrators in the electronic device are located at different positions. According to the vibration direction in the vibration information characteristics, the vibrators at different positions can be selected to vibrate.

It needs to explain that the above-mentioned embodiment of at least two vibrators is an example without any specific restriction.

Compared with the prior art, due to the different vibration intensities that electronic device users can feel under different conditions, the user's perception of the vibration information is determined by the current state of the electronic device, and then the vibration information is determined according to the current state of the electronic device. The vibration device vibrates according to the vibration information, and the user doesn't need to switch the vibration information. The electronic device can adjust the vibration information according to the current state, which prevents the user from missing the prompt information caused by no perception of the vibration, improves the intelligence of the electronic device and improves the user experience.

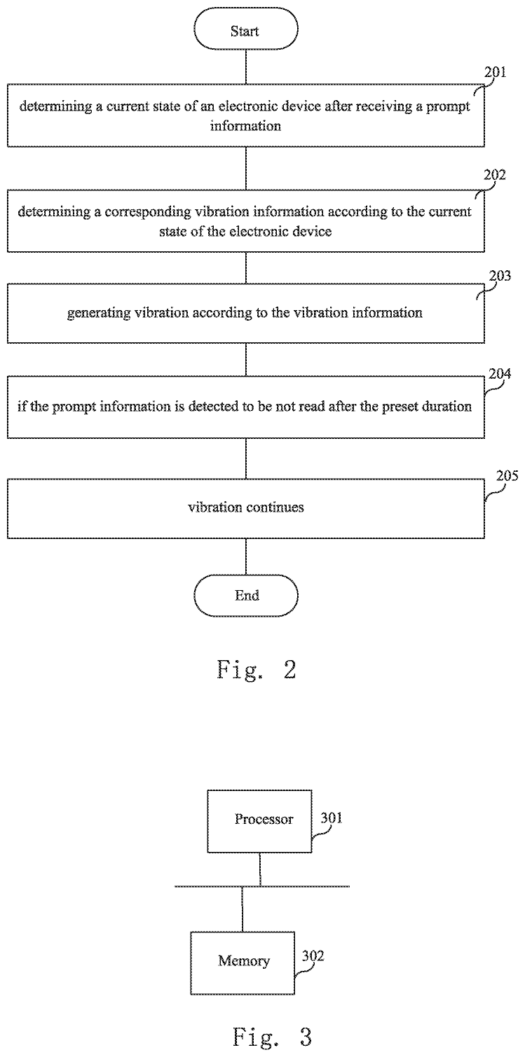

The second embodiment of the invention relates to an information prompt method. The embodiment is roughly the same as the first embodiment. The main difference is that the second embodiment describes the implementation method after vibration in detail. The specific flowchart is shown in FIG. 2.

It needs to explain that steps 201 to 203 in the embodiment are the same as steps 101 to 103 in the first embodiment, and not repeated here.

Step 204: if the prompt information is detected to be not read after the preset duration.

It needs to explain that the vibration information is determined according to the current state of the electronic device, so that the user can get the prompt information of the electronic device in time. It needs to detect whether the prompt information is read after the preset duration of the vibration sent out by the electronic device, for example, after the user receives the prompt information, the electronic device vibrates according to the current situation, and detects after 5 minutes to judge whether the prompt information is read. Specifically, the preset duration is set by the user. No restriction here.

Step 205: continue vibration.

Specifically, if the prompt information is not read, the electronic device continues vibration. It needs to explain that the vibration can be the same as the previous one, or the vibration can also be the vibration information determined after the current state of the electronic device is determined again, or the vibration is the vibration information based on the previous vibration after increasing the vibration intensity or prolonging the vibration duration. Here is just an example, and there is no specific restriction on the vibration after the preset duration.

Compared with the prior art, after detecting that the user has not read the prompt information, vibration is continued, which improves the intelligence of the electronic device and further improves the user experience.

The third embodiment of the invention relates to an electronic device of which the structure is shown in FIG. 3, including a memory 301 and at least one processor 302, wherein the memory 301 is communicated with the processor 302.

The memory 301 is used for storing instructions that can be executed by the processor.

The processor 302 is used for executing instructions stored in the memory.

The processor 302 is also used for executing the execution steps of the relevant information prompt method in the first and second embodiments.

Specifically, the processor 302 is used for determining the current state of the electronic device after receiving the prompt information, wherein, the current state of the electronic device includes the motion state and the static state. The corresponding vibration information is determined according to the current state of the electronic device; and vibration is generated according to the vibration information.

Specifically, the processor 302 is used to determine the vibration information characteristics corresponding to the current state of the electronic device. The vibration information is determined according to the vibration information characteristics, wherein, the vibration information includes the vibration information characteristics.

Specifically, the processor 302 is used to obtain the data information of the sensors in the electronic device, and the current state of the electronic device is determined according to the data information of the sensors.

Wherein, the memory and the processor are connected by a bus mode. The buses can include any number of interconnected buses and bridges. The buses link one or more processors with various circuits of the memory. The buses can also link various other circuits, such as peripherals, regulators, power management circuits, etc., which are well known in the field. Therefore, the paper doesn't further describe them. Bus interfaces provide interfaces between the buses and a transceiver. The transceiver can be either one component or a plurality of components, such as multiple receivers and transmitters, which provides units for communicating with various other devices on a transmission medium. The data processed by the processor is transmitted through the antenna on the wireless medium. Furthermore, the antenna receives the data and transmits the data to the processor.

The processor is responsible for bus management and general processing, and also provides various functions, such as timing, peripheral interface, voltage regulation, power supply management and other control functions. The memory is used for storing the data used by the processor in operation execution.

The fourth embodiment of the invention relates to a computer readable storage medium that stores a computer program which is capable of realizing the information prompt method mentioned in the first or second embodiment when executed by the processor.

The technicians in the field can understand that all or part of the steps for realizing the above-mentioned embodiments can be accomplished by directing the relevant hardware through a program stored in a storage medium, including all or part of the steps used by several instructions for making a device (such as a single chip computer, a chip, etc.) or a processor to execute the methods described in all embodiments of the invention. The above-mentioned storage media include: U disk, mobile hard disk, Read-Only Memory (ROM), Random Access Memory (RAM), a disk or CD-ROM, which can store program codes.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. An information prompt method, including steps of:
determining a current state of an electronic device after receiving a prompt information, wherein, the current state of the electronic device includes a motion state and a static state;
determining a corresponding vibration information according to the current state of the electronic device;
generating vibration according to the vibration information.

2. The information prompt method as described in claim 1, wherein the vibration information includes vibration information in the motion state and vibration information in the static state.

3. The information prompt method as described in claim 1, wherein the corresponding vibration information is determined according to the current state of the electronic device, including steps of:
determining the vibration information characteristics corresponding to the current state of the electronic device;
determining the vibration information according to the vibration information characteristics, wherein, the vibration information includes the vibration information characteristics.

4. The information prompt method as described in claim 2, wherein the corresponding vibration information is determined according to the current state of the electronic device, including steps of:
determining the vibration information characteristics corresponding to the current state of the electronic device;
determining the vibration information according to the vibration information characteristics, wherein, the vibration information includes the vibration information characteristics.

5. The information prompt method as described in claim 3, wherein the vibration information characteristics include at least one of a vibration duration, a vibration frequency, a vibration intensity and a vibration direction.

6. The information prompt method as described in claim 4, wherein the vibration information characteristics include at least one of a vibration duration, a vibration frequency, a vibration intensity and a vibration direction.

7. The information prompt method as described in claim 1, wherein determining the current state of the electronic device after receiving the prompt information includes steps of:
acquiring a data information of sensors in the electronic device;
determining the current state of the electronic device according to the data information of the sensors.

8. The information prompt method as described in claim 2, wherein determining the current state of the electronic device after receiving the prompt information includes steps of:
acquiring a data information of sensors in the electronic device;
determining the current state of the electronic device according to the data information of the sensors.

9. The information prompt method as described in claim 7, wherein the sensors include at least one of an acceleration sensor, a gyroscope sensor and a global positioning GPS sensor.

10. The information prompt method as described in claim 8, wherein the sensors include at least one of an acceleration sensor, a gyroscope sensor and a global positioning GPS sensor.

11. The information prompt method as described in claim 3, wherein if the electronic device includes at least two vibrators, the step of generating vibration includes steps of:
acquiring the vibration information characteristics in the vibration information;
determining a corresponding vibrator according to the vibration information characteristics;
sending out the vibration information through the corresponding vibrator.

12. The information prompt method as described in claim 4, wherein if the electronic device includes at least two vibrators, the step of generating vibration includes steps of:
acquiring the vibration information characteristics in the vibration information;
determining a corresponding vibrator according to the vibration information characteristics;
sending out the vibration information through the corresponding vibrator.

13. The information prompt method as described in claim 2, wherein after the vibration is generated according to the vibration information, the information prompt method further includes:
if the prompt information is detected to be not read after the preset duration, the vibration continues.

14. The information prompt method as described in claim 11, wherein after the vibration is generated according to the vibration information, the information prompt method further includes:
if the prompt information is detected to be not read after the preset duration, the vibration continues.

15. The information prompt method as described in claim 12, wherein after the vibration is generated according to the vibration information, the information prompt method further includes:
if the prompt information is detected to be not read after the preset duration, the vibration continues.

16. An electronic device including:
at least one processor; and
a memory communicating with the processor; wherein,
the memory stores instructions that can be executed by the processor to execute the information prompting method as described in claim 1.

17. A computer readable storage medium which stores a computer program, wherein when the computer program is executed to perform the information prompt method as described in claim 1.
